(19) United States
(12) Patent Application Publication
(10) Pub. No.: US 2004/0194022 A1
(43) Pub. Date: Sep. 30, 2004

(54) Kernel configuration tool

(76) Inventors: Christophe Cleraux, Sene (FR); Frederic Leger, Foch (FR)

Correspondence Address: Davidson, Davidson & Kappel, LLC, 14th Floor, 485 Seventh Avenue, New York, NY, 10018, US

(21) Appl. No.: 10/402,336

(22) Filed: Mar. 28, 2003

(51) Int. Cl. G06F 15/00

(52) U.S. Cl. 715/513

(57) ABSTRACT

In an embodiment according to the present invention, a method for creating a kernel config file is provided. A plurality of selections are entered into a document. Each selection corresponds to one or more components. The document comprises a set of rules for entering the selections and for identifying one or more dependencies of the components. The dependencies are identified based on the set of rules. If an unresolved dependency is found the step of entering is repeated. If no unresolved dependency is found, a kernel configuration file is built based on the document.

A portion of the disclosure of this patent document contains material which is subject to (copyright or mask work) protection. The (copyright or mask work) owner has no objection to the facsimile reproduction by any one of the patent disclosure, as it appears in the Patent and Trademark Office patent files or records, but otherwise reserves all (copyright or mask work) rights whatsoever.

### BACKGROUND INFORMATION

A computer program can be viewed as a detailed plan or procedure for solving a problem with a computer: an ordered sequence of computational instructions necessary to achieve such a solution. The distinction between computer programs and equipment is often made by referring to the former as software and the latter as hardware. A computer program (e.g., an application) interacts with an operating system (OS) to access hardware. The OS is a set of computer programs that controls the interaction with the hardware. In conventional computer systems, the OS provides generalized system services to application programs, such as utility and daemon programs. These system services conventionally include access to hardware peripheral devices attached directly or indirectly to the computer system. Applications are generally OS specific (i.e., an application can execute on a first OS, but not a second OS).

However, a generic language, such as XML (Extensible Mark-Up Language), can be used to perform different functions across a variety of OSes. To do so, an interpreter specific to each OS is present on that OS. XML acts as a markup language for documents containing structured information. Structured information contains both content (words, pictures, etc.) and some indication of what role that content plays (for example, content in a section heading has a different meaning from content in a footnote). Since containers are a form of structured information, XML allows a programmer to create a customized mark-up language to display the containers. XML can also be used to define a UI (User Interface). The UI allows a user or another program to communicate with an application or the OS itself or to perform a particular function on the system. For example, the UI can then be used to modify or create various files. Moreover, the UI can be used across different platforms that have the interpreter for XML.

A variety of different schemes exist for implementing OSes. For example, OSes can be implemented as a microkernel and component architecture. In such systems, the microkernel usually contains the most heavily used portions of the operating system, such as process management and handling of device interrupts. Components, however, contain portions of the operating system that are not used as frequently, for example, device drivers specific to hardware and libraries specific to certain application.

To form a functioning OS, the components are integrated into the microkernel to form a kernel. This is sometimes known as a build. The kernel can then be stored in binary format, known as an image, on a memory device, such as a hard drive. For example, in Linux, a Unix based OS, the OS is generated by forming a configuration file, setting all the source dependencies, compiling source code files into object files, and then linking the object files to form an image.

Since different applications may require different components, configuration tools are used to configure an OS for a particular application. The configuration tools verify that the operating system is coherent and fits the application needs. For example, a configuration tool can perform a dependency analysis to verify that all the components that the application needs are present and properly initialized. Such a dependency analysis can find all the dependencies between a first component of an OS and any other components the first component uses to function. A configuration file can be used to store the particular configuration generated by the configuration tool, so that a particular configuration can be ported to (e.g., used with) different computing systems without having to use the configuration tools for each system. Also, in case of a hardware failure, the configuration file for a particular system can be used to specify which components were needed or were in use for that system.

A user may want to change certain items of the configuration file without executing the configuration tools. Moreover, the configuration tool may not support certain changes that the user wishes to make, or the user may be able to create a configuration file that is superior to any configuration file generated by the configuration tools. However, configuration files are often cryptic and difficult to understand, so applications have been developed to create and modify configuration files. The applications operate on a particular OS configuration and are not easily ported across different OSes and/or system architectures.

### SUMMARY OF THE INVENTION

In a first embodiment according to the present invention, a method for creating a config file is provided. A plurality of selections are entered into a document. Each selection corresponds to one or more components. The document comprises a set of rules for entering the selections and for identifying one or more dependencies of the components. The dependencies are identified based on the set of rules and if an unresolved dependency is found the step of entering is repeated. If no unresolved dependency is found, a configuration file is built based on the document.

In a second embodiment according to the present invention, a method for creating a make file is provided. A plurality of selections are entered into a document. Each selection corresponds to one or more components. The document comprises a set of rules for entering the selections and for identifying one or more dependencies of the components. The dependencies are identified based on the set of rules. If an unresolved dependency is found the step of entering is repeated. If no unresolved dependency is found, one or more makefiles are built based on the document.

In a third embodiment according to the present invention, a method for creating a configuration data is provided. A plurality of selections are entered into a document. Each selection corresponds to one or more components. The document comprises a set of rules for entering the selections and for identifying one or more dependencies of the components. The dependencies are identified based on the set of rules. If an unresolved dependency is found the step of entering is repeated. If no unresolved dependency is found, a configuration file is built based on the document. Also, if no unresolved dependency is found, one or more makefiles are built based on the document.

In a fourth embodiment according to the present invention, a method for creating a configuration file is provided. A plurality of selections are entered into user interface. Each selection corresponds to one or more components. A set of rules is provided for entering the selections and for identifying one or more dependencies of the components. The dependencies are identified based on the set of rules. If an unresolved dependency is found the step of entering is repeated. If no unresolved dependency is found, a configuration file is built based on the user interface file. A makefile can also be built.

### BRIEF DESCRIPTION OF THE DRAWINGS

FIG. 1 shows a first and second set of components as they relate to a first and second microkernel.

FIG. 2 shows a method for generating a configuration file with an XML document.

FIG. 3 shows an exemplary system using the present invention.

FIGS. 4(a,b,c) shows the XML elements used to generate the UI and the kernel.

FIG. 5 shows a main window from the UI.

FIG. 6 shows a name creation window from the UI.

FIG. 7 shows a create project from window from the UI.

FIG. 8 shows a create project from an existing configuration file window from the UI.

FIG. 9 shows a create project from a BSP (Board Support Package) window from the UI.

FIG. 10 shows a summary window from the UI.

FIG. 11 shows an options view from the UI.

FIG. 12 shows an options menu from the UI.

FIG. 13 shows a device view from the UI.

FIG. 14 shows a device menu from the UI.

FIG. 15 shows a pseudo-device view from the UI.

FIG. 16 shows a config view from the UI.

FIG. 17 shows a text view from the UI.

FIG. 18 shows a file view from the UI.

FIG. 19 shows a variable view from the UI.

FIG. 20 show a user defined kernel configuration options view from the UI.

FIG. 21 shows a build output window from the UI.

### DETAILED DESCRIPTION OF THE PREFERRED EMBODIMENTS

In certain embodiments according to the present invention, an XML document is used to define the dependencies and configurations for an OS build. The XML document can include all of the dependencies for all of the possible configurations and defines UI (User Interface) elements for selecting various options. Subsequent selections and identification of any dependencies are defined by the logic in the XML document.

In the above mentioned embodiment of the present invention, one or more sets of rules used to define the dependencies and configurations can be mixed together throughout the XML document. The XML document could be used to display comments and allow data entry. The document XML could also be used to check any dependencies that may occur.

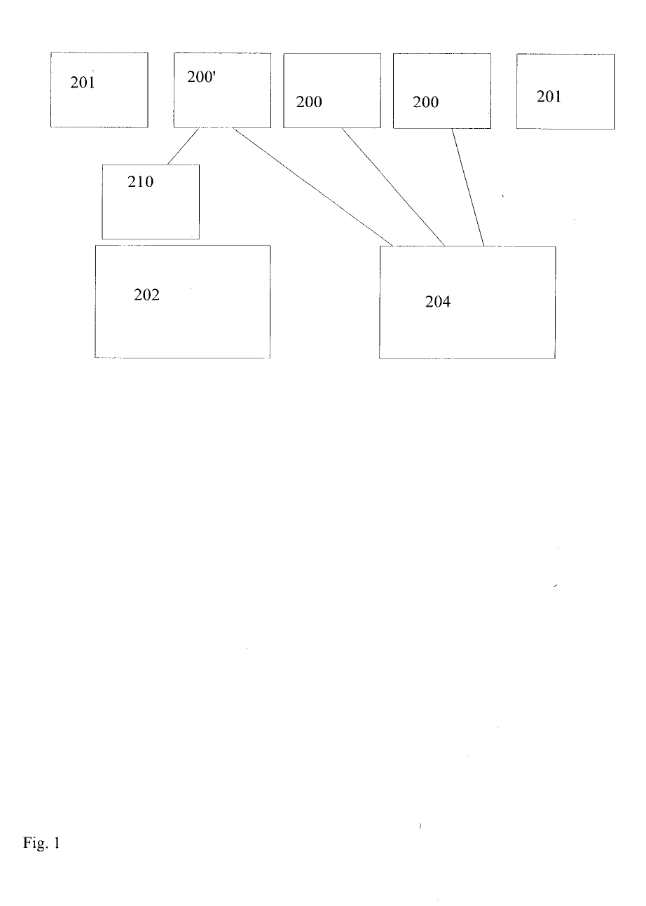

FIG. 1 shows a first and second set of components 200,201 as they relate to a first and second microkernel 202,204. The components 200,201 and one of the microkernels 202,204 are combined in the build step to form a working kernel. For example, the first set of components 200 and the second microkernel 204 could be used to form the kernel. A configuration file is used to define which components and which microkernels are used to form the particular kernel. The components 200,201 each impart different functionality to the resulting kernel. For example, the components 200,201 could allow the resulting kernel to interface with devices that an application uses or to impart functionality to the application. As such, the components 200,201 might be a data base tool or a set of mathematical functions that are necessary for a particular application. The components 200,201 could also provide an interface with a back-end of the application or provide support for particular functions of the kernel itself.

In certain embodiments according to the present invention, one of the sets of components 200,201, or a member thereof is dependent on a third component 210 (e.g., it needs to interact with that component to function correctly). In this illustration, one of the first components 200′ uses a third component 210 to function correctly. Thus, the third component 210 is also included in the resulting configuration file (e.g., a file with a “.bsd” extension, in the context of a UNIX based OS) used to generate the kernel.

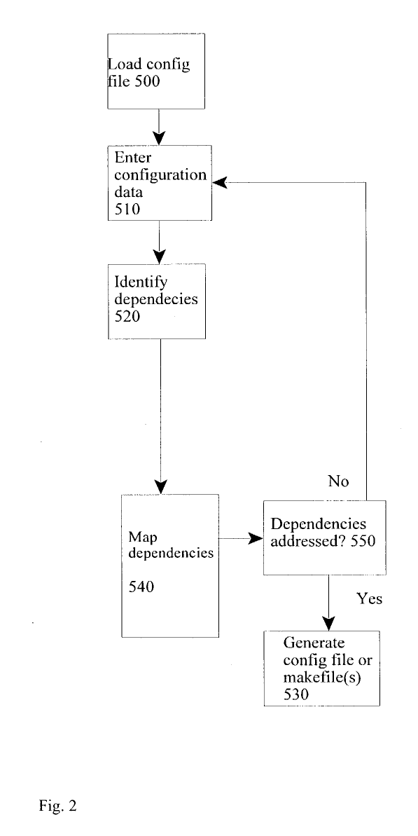

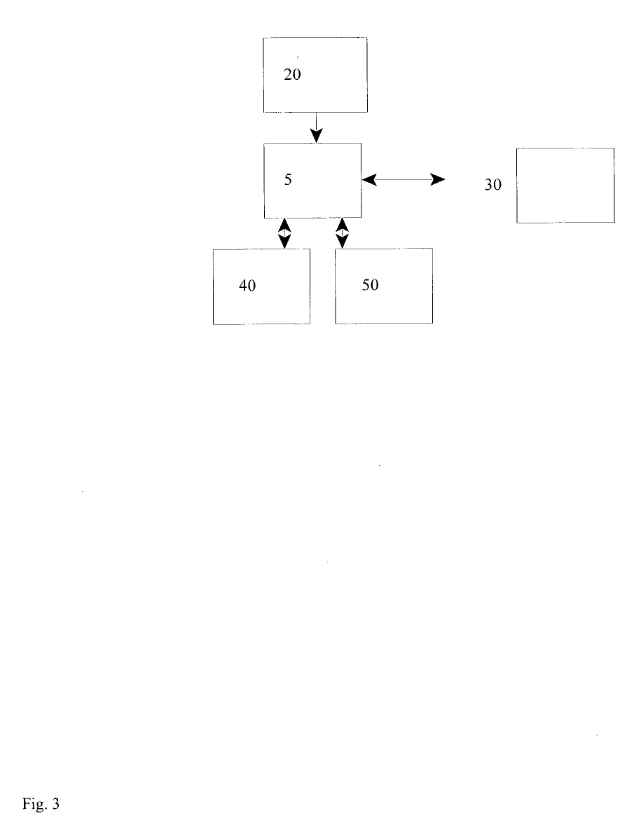

FIG. 2 shows a method for generating a configuration file with an XML document 20 (shown in FIG. 3). A configuration file 40 (shown in FIG. 3) is loaded (Step 500). In certain embodiments according to the present invention, the configuration file 40 can be created by the XML document 20, so the step of loading the configuration file 40 can be omitted or a blank configuration file 40 can be loaded.

A user enters configuration data via a configuration tool, and the XML document 20 is used to validate the configuration data. (Step 510). For example, the user can select one or more components or particular functions that are to be included in the resulting kernel. The XML document 20 defines rules to describe any dependencies in a kernel configuration. The XML document 20 also comprises support for any devices (e.g., a modem) or options (e.g., sound support) used by the kernel. The XML document 20 also provides support for resolving dependencies. In certain embodiments according to the present invention, the XML document 20 also includes support for any source files that are used to generate the kernel. The user can interact with the XML document 20 via a UI 5 that is defined by the XML document. An exemplary UI is shown in FIGS. 5-21 and will be discussed infra. In certain embodiments of the present invention, the XML document 20 is useable over a variety of operating systems. For example, each of the operating systems could have an interpreter program for XML.

The devices and the options the user entered are parsed to identify dependencies (Step 520). For example, components that a selected component uses in order to function correctly can be identified. Also, components that are used by a particular function that is to be included in the resulting kernel can be identified.

The dependencies identified in Step 520 are mapped against the configuration file 40 to ensure compliance (Step 540). In this context, the mapping of the “configuration file” is performed on the configuration file data which was loaded into memory in step 500. If there are dependencies that are not adequately addressed in the configuration file 40 (hereafter referred to as “unresolved dependencies”), the method returns to Step 510, and the user is informed of the unresolved dependencies that are not addressed in the configuration file 40 (Step 550). For example, the user can be notified that a component (e.g., a driver) used to interface correctly with a hardware item is not present. The user can also be notified that certain components the kernel uses to function correctly are not present. For example, the user can be notified that a particular component used to provide support for dynamic objects and shared libraries (e.g., a component providing support for ELF(Executable and Linkable Format)) is not present in the configuration file 40. The user could also be notified that a particular component used by another component to function correctly is not present. Preferably, one or more components that would resolve the dependency are displayed to the user, and the user is allowed to select the component(s) that would resolve the dependencies(s). In certain embodiments according to the present invention, Step 500 is omitted and the user can enter all configuration data into a configuration view in the XML document. The data in the configuration view could then be used to generate the configuration file 40 once the dependencies are addressed.

The XML document is then used to generate a configuration file 40 (Step 530). The configuration file specifies the kernel(s) to be built, the files that are used to make the kernel, and, in some cases, the commands to execute in order to make the kernel. The XML document also comprises the data to generate the makefile(s). Therefore, in certain embodiments of the present invention, the data can be used to directly generate a makefile(s). For example, instead of generating a configuration file from the configuration data and then using the configuration file to generate the makefile(s), the generation of the configuration file may, in certain embodiments, be omitted, and the makefile(s) generated directly. However, it should be apparent to one skilled in the art that omission of the configuration file is not necessary to generate the makefile(s) and that configuration files and makefile(s) could both be generated.

Preferably, steps 520 through 540 are performed by a configuration tool performing operations on the XML file.

FIG. 3 shows an exemplary system in accordance with the present invention. Via an interface 5 (e.g., a user interface) a user reads the XML document 20. A database 30 is maintained in memory by the interface 5. The database 30 is based on the XML document and includes the dependency rules and configuration data. When step 530 of FIG. 2 is performed, the interface 5 generates configuration files 40, according to database 30 rules. The configuration file 40 can be located on the same processing device as the XML document 20, or on a separate processing device(s). Preferably, the interface 5 comprises a search utility for finding files and help facility to provide the user with useful information pertaining to various functions of the interface 5.

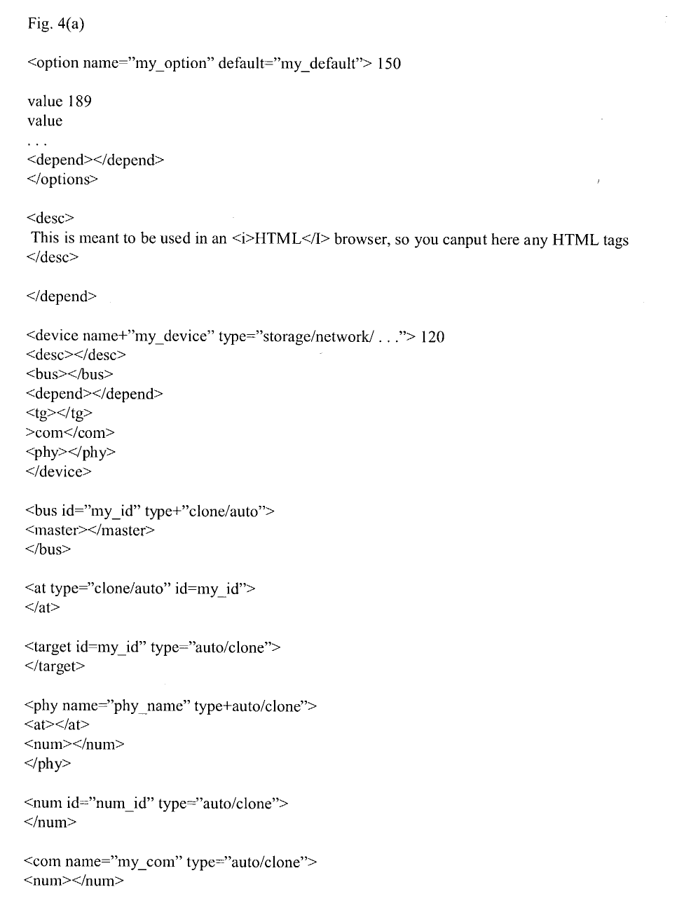

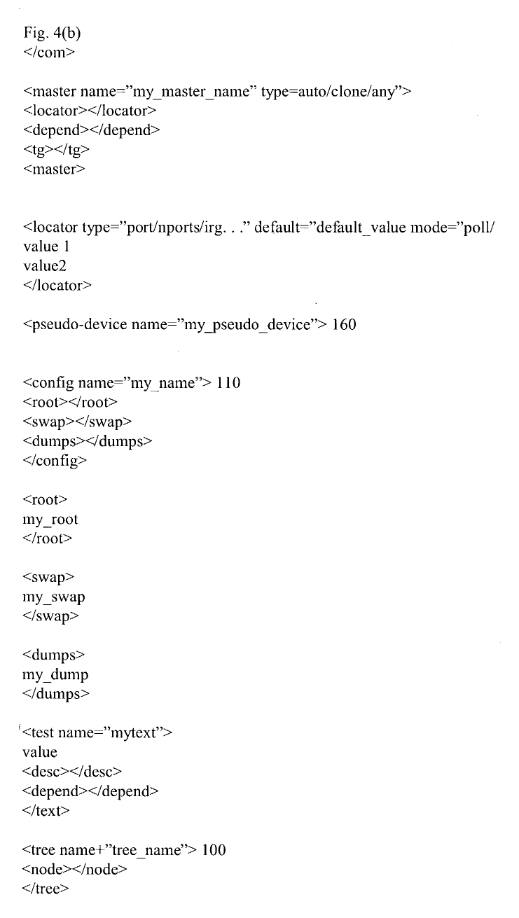

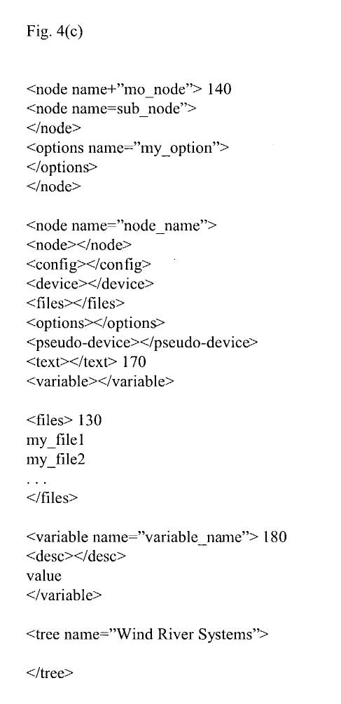

FIGS. 4(a,b,c) shows an exemplary XML document 20 used to generate the UI and a configuration file. Reference numbers are 100 through 180 are provided for identification purposes and do not form part of the XML document. The XML document 20 comprises one tree node 100. The tree node comprises a plurality of nodes arranged in a tree structure with the tree node 100 as the root. Such nodes can be a config node 110, device node 120, files node 130, node node 140, options node 150, pseudo-device node 160, text node 170, and a variable node 180. The different nodes 100, 110, 120, 130, 140, 150, 160, 170, 180 are used as elements to generate the UI (shown in the subsequent FIGS. 5-21). Each of the nodes 100, 110, 120, 130, 140, 150, 160, 170, 180 can further comprise certain strings that further define the elements of the node. For example, the nodes could have a value string 189. Preferably, each of the nodes 100, 110, 120, 130, 140, 150, 160, 170, 180 and/or elements therein is related to one or more components that can form part of the kernel. When a user enters information into the XML document 20 in Step 520, the nodes 100, 110, 120, 130, 140, 150, 160, 170, 180 and/or the information therein is changed. Moreover, when the XML document 20 is used to generate the configuration file or the makefile(s) in Step 530, the nodes 100, 110, 120, 130, 140, 150, 160, 170, 180 and/or the information therein is used to generate the configuration file and/or the makefile(s).

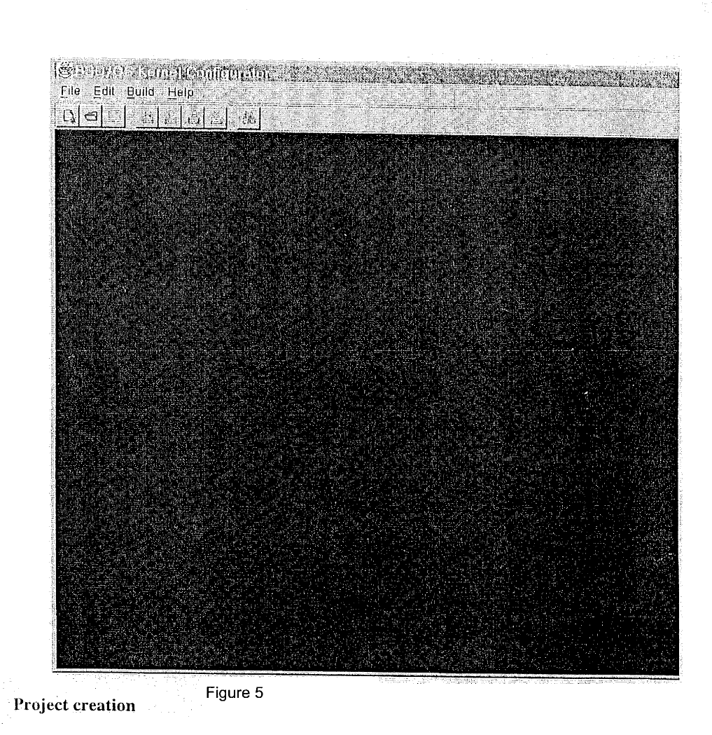

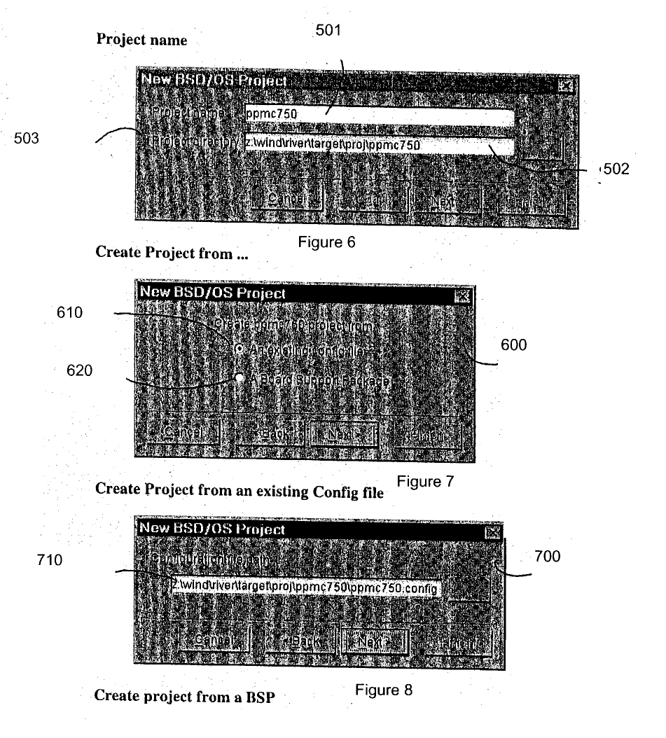

In FIGS. 5-21 below, the data from the XML document 20 is used to generate the different aspects of the UI. In this example, the UI is a typical interface which includes a main display with a menu and toolbar (see, e.g., FIGS. 5, and 11-21), as well as pop-up displays (see, e.g., FIGS. 6-10).

FIG. 5 shows a project creation display from the UI. As such, this screen can be displayed while the configuration file is loaded (Step 500). This screen could also be displayed when configuration data is entered (Step 510). For example, the project creation display could allow a user to associate the kernel with a project name.

FIG. 6 shows a Project Name pop-up display 503 from the UI. The Project Name screen allows a project name to be specified in a project name field 501 and a project directory to be specified in a project directory field 502. The Project Name pop-up display 503 from the UI could be displayed during step 510.

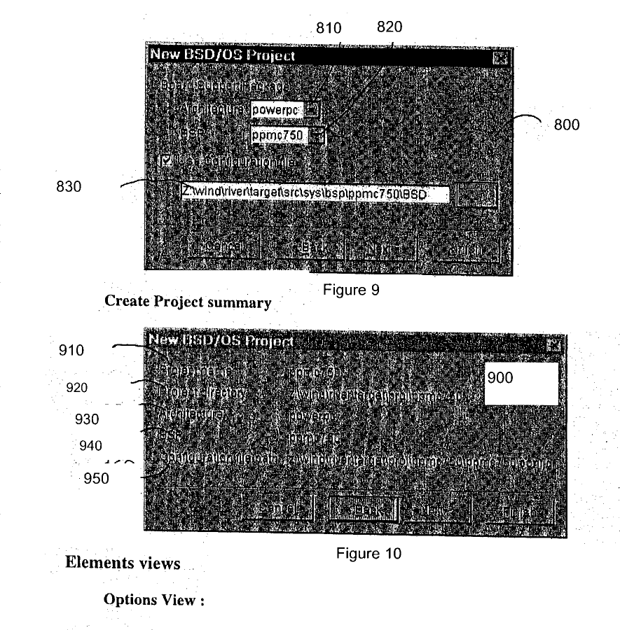

FIG. 7 shows a Create Project From display 600 from the UI. A user can make a selection between modifying an existing configuration file or using a board support package configuration file by selecting a first selector 610 or a second selector 620. FIG. 8 shows a Create Project From an Existing Configuration File screen 700 from the UI. If the user selects to modify an existing configuration file in FIG. 7 the create project from an existing Configuration File display 700 is displayed. The user can enter a configuration file path in a configuration file path text box 710. FIG. 9 shows a Create Project from a BSP (Board Support Package) display 800 from the UI. This is displayed after the user selects a “A Board Support Package” from FIG. 7. A user can enter a board support package architecture and a BSP by entering text into a first and second create project text box 810,820. A user can also enter a configuration file path in a configuration file path text box 830. Each of these displays correspond to Step 510, described above.

FIG. 10 shows a Summary Display window 900 from the UI. The project name, project directory, architecture, BSP, and/or configuration path are displayed in a first, second, third, fourth, and fifth display area 910,920,930,940,950, respectively.

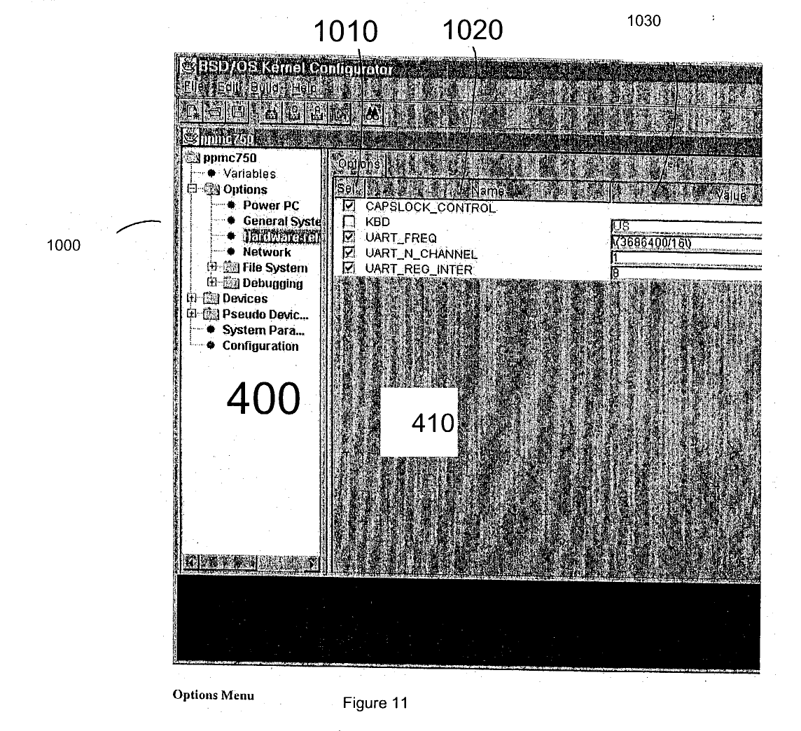

In FIGS. 11-21 a tree panel 400 displays the nodes and groups of elements that are defined in the XML document. For example, display options, devices, or pseudo-devices elements could be displayed as a node. Preferably, if one of the nodes (e.g., a configuration element) is selected (e.g., by a user selection or a software tool), the selected node appears in bold. The selection process functions recursively, so that any parent of a node also appears in bold (e.g., Step 520). If a selected node (e.g., element) has dependencies, the user is prompted to either 1) keep the selected node and add the needed dependent elements, or 2) to unselect the selected nodes (e.g., Steps 540,550). Each of the nodes may be associated with a popup menu that includes selectors (e.g., icons) for expanding/collapsing the node, finding an item (e.g., an element or file associated with an element), selecting or unselecting all nodes, selecting a default, and querying a help utility. Preferably, a help message associated with the node can be displayed by pressing a key (e.g., the F1 key).

A table panel 410 is also provided. The table panel 410 displays one or more elements present in the selected node. For example, the table panel can display one or more of the options elements (e.g., of the tree node), device elements, pseudo-device elements, config elements, or text elements. Selection or modification of the elements results in a modification of the generated configuration file or makefile(s). Preferably, the elements are related to different components.

FIG. 11 shows an options view 1000 from the UI. The options menu displays any option element in three columns. An option is a kernel component that is not tied to a specific device, but may use the specific device (e.g., a driver). For example, if NFS (Network File Server available for Sun Microsystems), which is not related to any network devices, is selected, a network device is still used to allow NFS to function. Such a network device could be selected as an option. As another example, an options element relating to a component for control of a capslock function could be displayed. Also, various elements relating to components for UART (universal asynchronous receiver/transmitter) functions could be displayed. The columns are a selected status 1010, name 1020, and value column 1030. In the status column 1010, the “selected status” is shown as check in a box. If the options element status is not “selected,” the option's values are not editable, and the options will not appear in the generated configuration file or makefile(s). The name column 1020 for the options element displays a character string associated with the options element. The value column 1030 displays nothing if no values are associated with the options element. If the options element has one value associated with it, the value is displayed in a text field, and the options element can be selected. If the options element has a plurality of values associated with it, the values are displayed in a drop down list (e.g., a combo box). One of the values can then be selected. The options view 1000 allows a user to enter configuration data with regard to the options (e.g., Step 510).

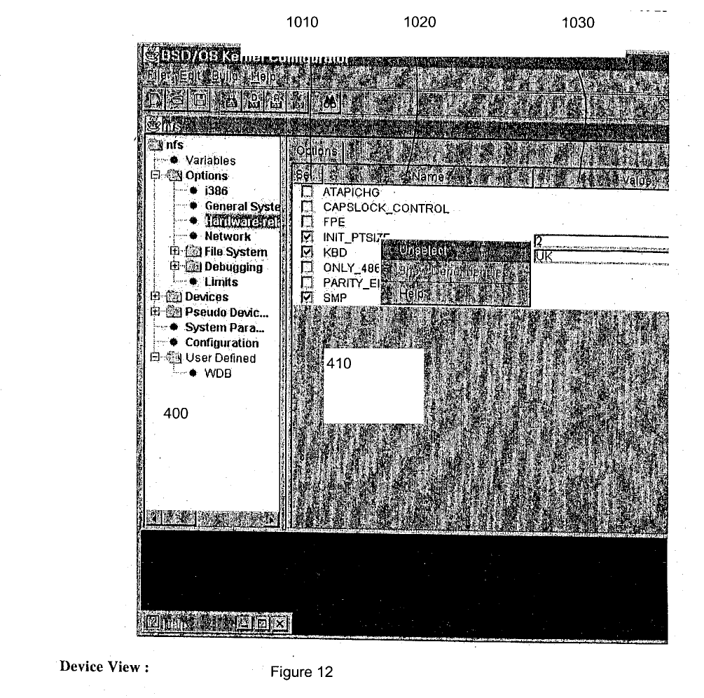

Moreover, each options element displayed in the table has a popup menu associated with it (shown in FIG. 12). The popup menu comprises a select/unselect item, a show dependencies item, and a help item. Pressing a key (e.g., the F1 key) displays help information associated with the selected option element. By selecting the show dependencies item, the user can trigger the start of Step 520.

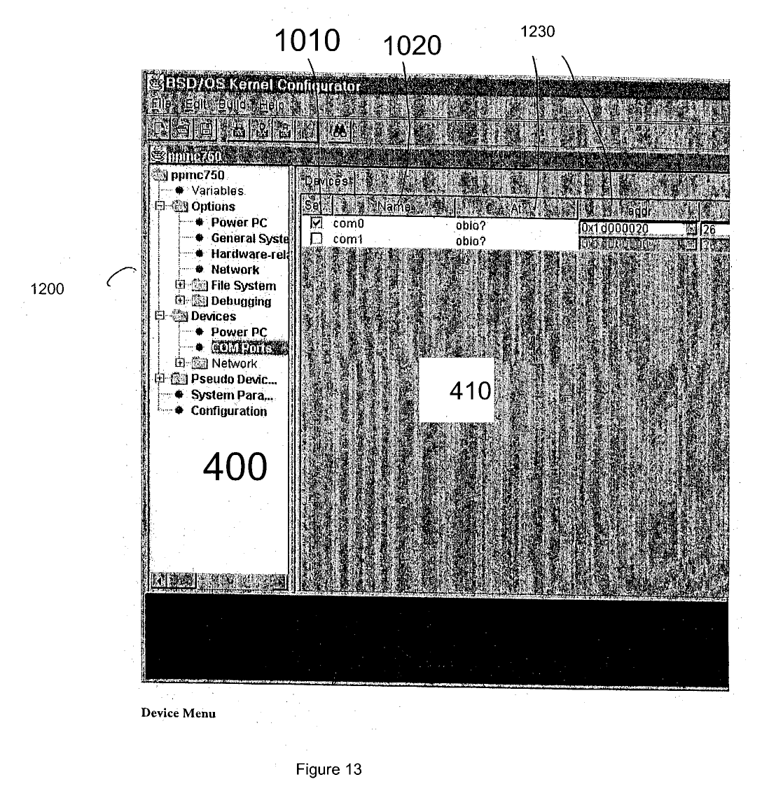

FIG. 13 shows a device view 1200 from the UI. A device is a software component that is used along with a hardware device, for example, a network adaptor. The device view 1200 is displayed in at least three columns and includes at least one bus element and at least one master device element (e.g., for each bus). For example, a device element that relates to a component for control of a communications port could be displayed. The columns are a selected status 1010, name 1020, and master device column 1230. The master device column can further comprise device characteristics. Other columns can also be displayed, for example, a locator column could also be displayed. The selected status 1010 pertains to whether or not the master device is currently selected. This is shown as a check box in a box. The name 1020 relates to a character string comprising the real device name and the bus on which it is defined. For example, device my_device defined for bus 0 displays my_device0 as the character string. The master device column 1230 displays a character string comprising the real device name and the bus on which it is defined. If the master device is in auto mode, clone mode, a “?,” “*,” can be appended to the name, respectively. If the master device is in “any” mode, the name is replaced with “any”. For example, if the XML node is master name=“my_master” id=2″, the UI displayed value is my_master2. If the master name=“my_master” type=“auto”, the UI displayed value is my_master?. If locators are present they are displayed in a pull down menu (e.g., a combo box) in the columns based on the order that they appear. Also, depending on the locators characteristics a value may also appear in the column. For example, if the locator mode is “pollable,” a “none” value appears in the combo box. For locators in “poll,” the “none” value is selected at start up. For locators with several values, an “all” value is added to the pull down menu. If the locator is in “exclusive” mode, the “all” value is removed and the user is not allowed to select several values. The device view 1200 allows a user to enter configuration data with regard to the devices (e.g., Step 510).

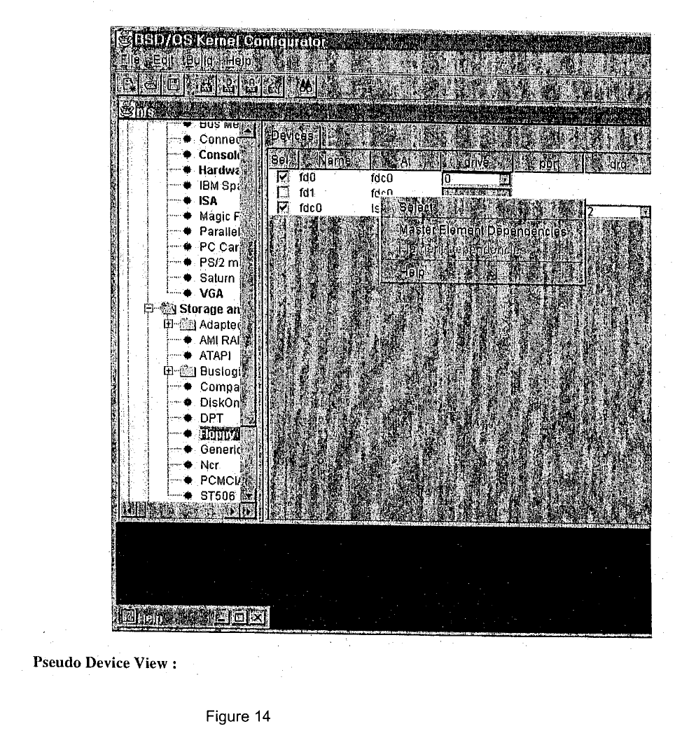

The device element can be displayed over more than one line depending on the number of busses and master devices it has. Each device element displayed in the table has a popup menu associated with it. The popup menu comprises a select/unselect item, a master device dependencies, a show dependencies item, and a help item (shown in FIG. 14). Pressing a key (e.g., the F1 key) displays help information associated with the selected device element.

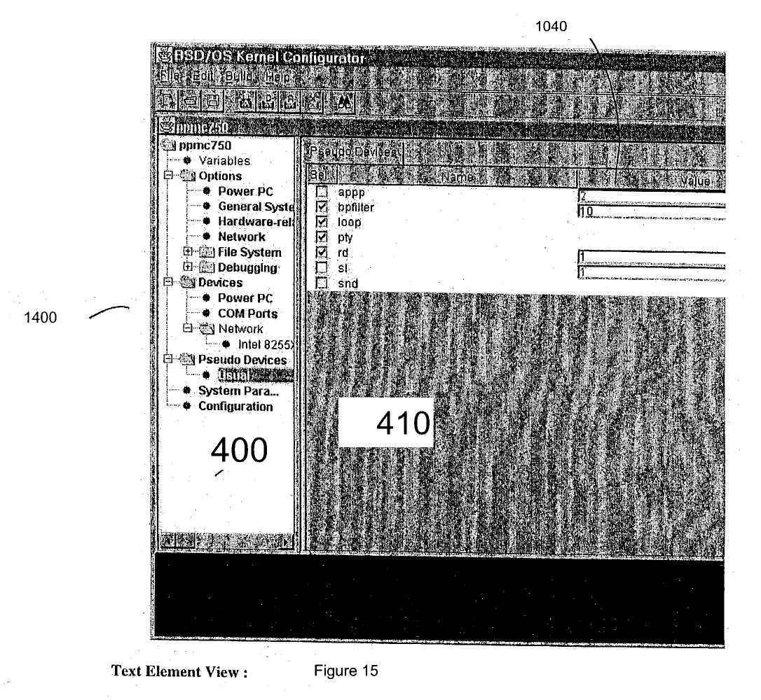

FIG. 15 shows a pseudo-device view 1400 from the UI. A pseudo-device is a component that is seen by an application as a device. However, unlike the device, the pseudo-device is not tied to any actual hardware device. For example, a terminal device handled by the kernel, but having no hardware associated with it, could be listed as a pseudo-device. The pseudo-device view 1400 is displayed the same as the options view 1000, except for two exceptions. The first exception is that the pseudo-device elements are displayed instead of option elements. The second exception is that the value column 1040 displays a text field or nothing, depending on the value associated with the pseudo-device 1400. The pseudo-device view 1400 allows a user to enter configuration data with regard to the pseudo-devices (e.g., Step 510).

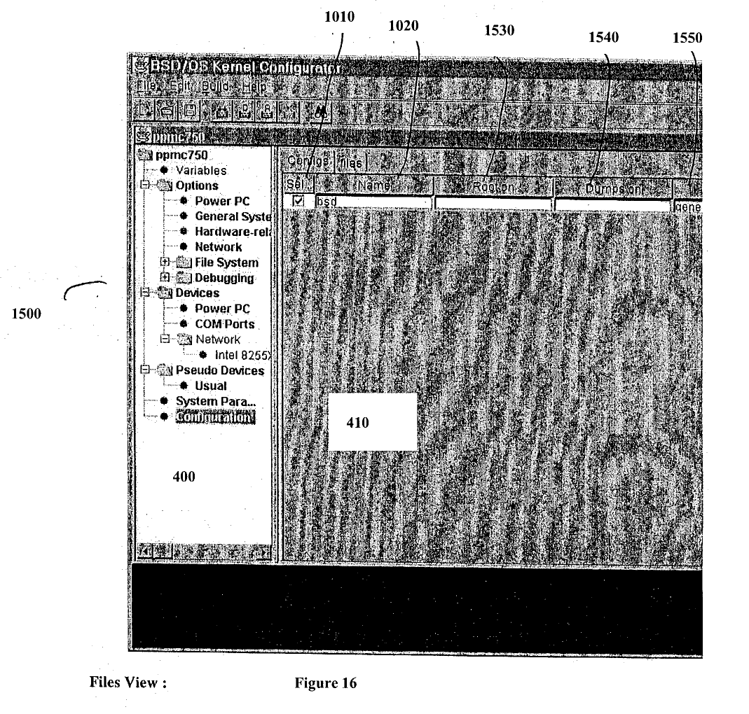

FIG. 16 shows a config view 1500 from the UI. The config view 1500 is displayed over five columns. The columns are selected status 1010, name 1020, root on 1530, dumps on 1540, and swap on 1550 and are used to display a config element(s). For example, a config element that relates to a component for generating a BSD kernel could be displayed. The selected status 1010 is a check box that displays whether a particular config element is selected. If the config element 350 is not selected the config element's values are not editable. The name column 1020 can comprise any regular file name. The root on 1530 column displays the kernel root device in a text field. The dumps on 1540 column displays the kernel dumps device in a text field. The swap on 1550 column displays the name of device(s) where the kernel can be swapped. A “generic” keyword can be used to generate a “swap generic” character string in the configuration file. The config view 1500 allows a user to enter (e.g., in Step 510) configuration data that can be used to identify dependencies in Step 520.

A popup menu is also associated with each config element. The popup menu is the same as the popup menu associated with the options element (shown in FIG. 12).

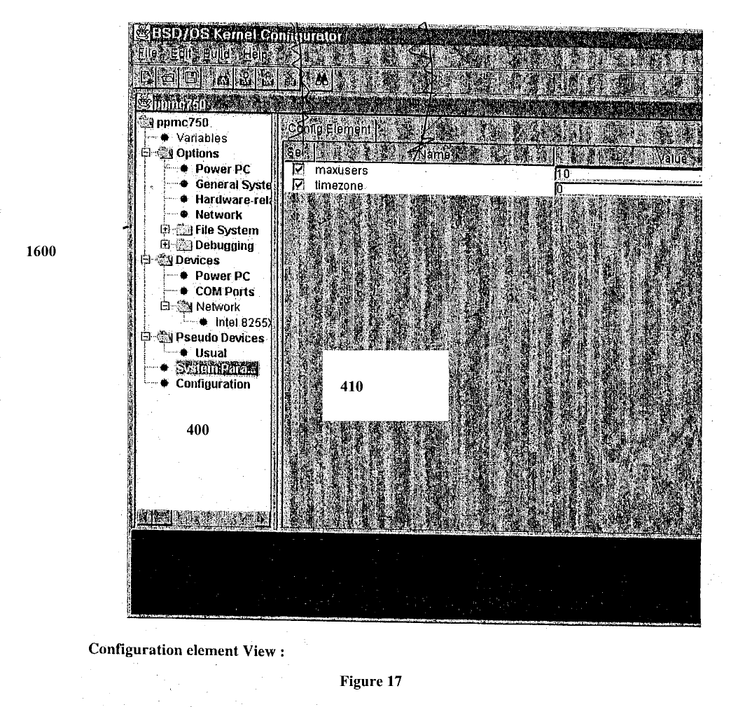

FIG. 17 shows a text view 1600 from the UI. The text view 1600 is displayed the same as the options view 1000, except that characteristics of text elements are displayed instead of options elements in the columns. For example, a text element that relates to a component for a time zone or a maximum number of users could be displayed. The text view 1600 allows a user to enter (e.g., Step 510) configuration data that can be used to identify dependencies (e.g., Step 520).

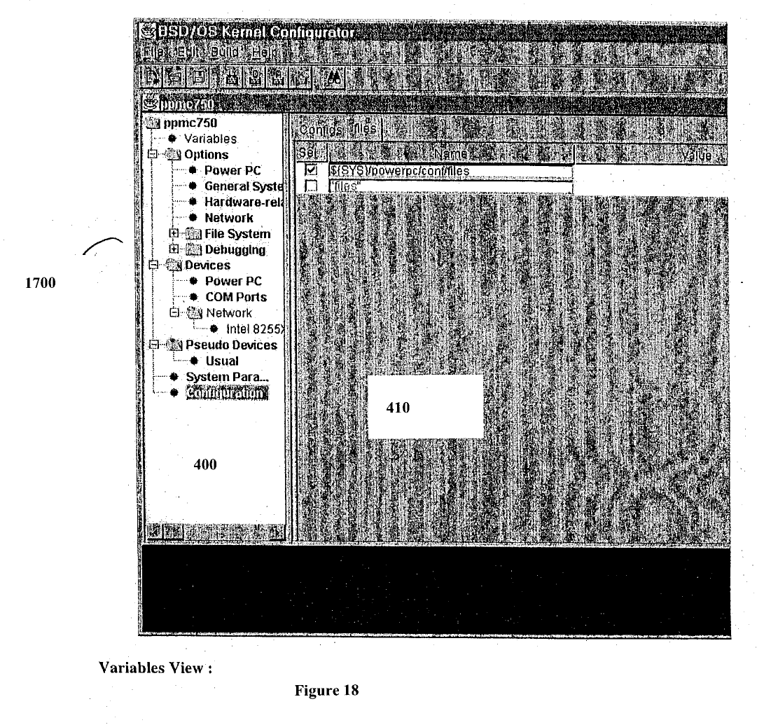

FIG. 18 shows a file view 1700 from the UI. The file view 1700 is displayed the same as the options view 1000, except that characteristics of file elements are displayed instead of options elements in the columns. Generally, a file has one value, so the combo-box for the file does not have to be used to display its options. For example, the path of a component could be displayed. The file view 1700 also allows a user to enter (e.g., Step 510) configuration data that can be used identify dependencies (e.g., Step 520).

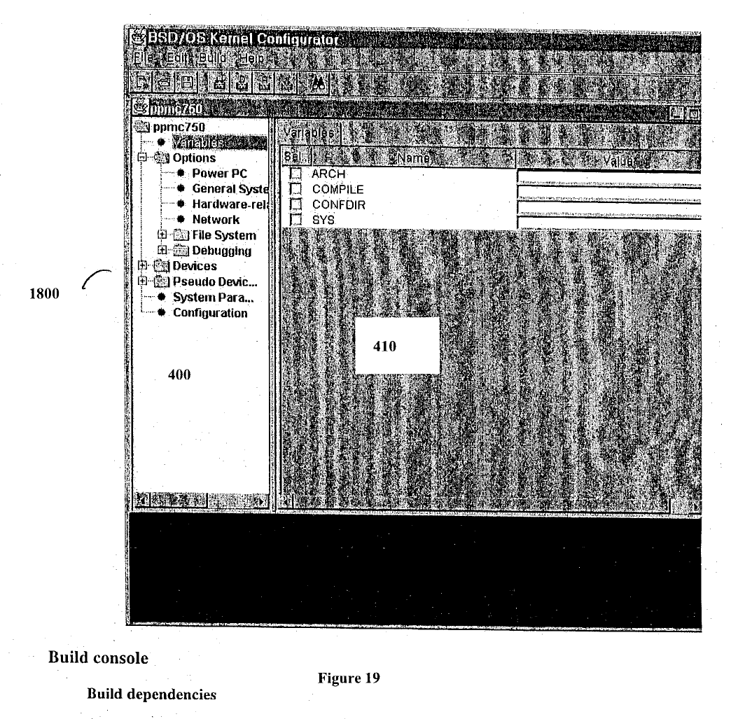

FIG. 19 shows a variable view 1800 from the UI. The variable view 1800 is displayed the same as the options view 1000, except that characteristics of variable elements are displayed instead of options elements in the columns. The variables are passed as parameters to the config file or makefile that is generated. The variable could include, for example, compiler options. The variable view 1800 allows a user to enter (e.g., Step 510) configuration data with regard to variables that can be used identify dependencies (e.g., Step 520).

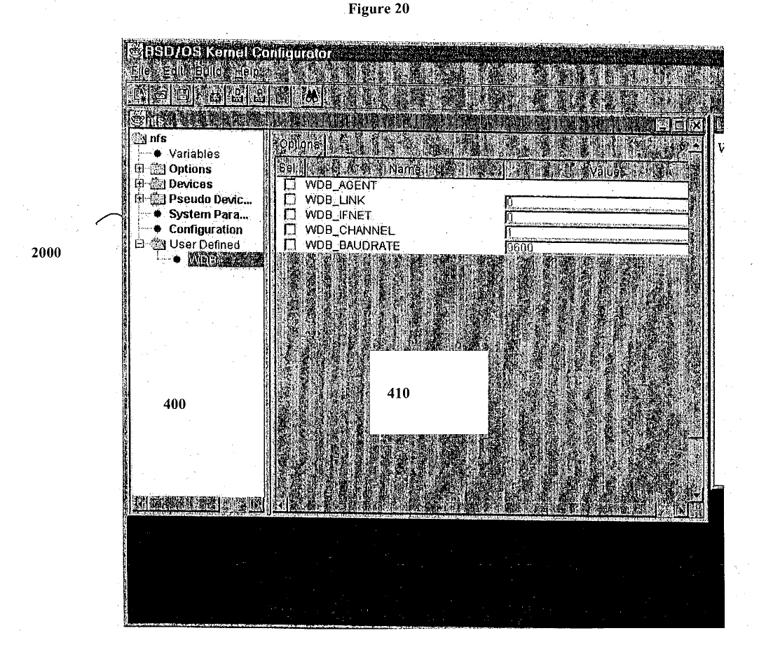

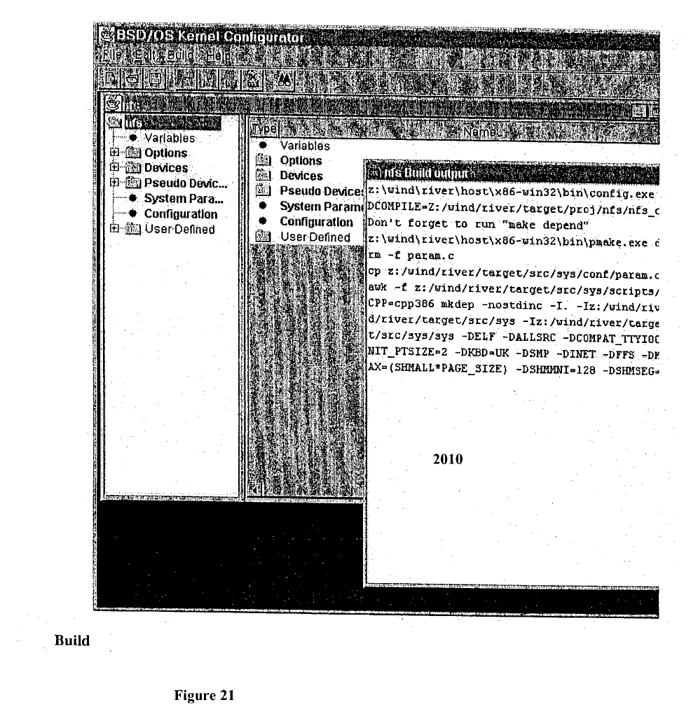

FIG. 20 shows a user defined view. The user defined view is based on a user provided XML file which may follow XML syntax of FIG. 3. User view may display any of the above defined views (From options view 1000 to variable view 1800). For example, if the user defines an XML file with options related to WDB, such as WDB_AGENT or a WDB_BAUDRATE, the user view would display them as shown in FIG. 20. The user view 2000 allows user to enter (e.g., in step 510) configuration data which are not part of the standard defined configuration elements, and make them appear in the generated kernel configuration file 40.

FIG. 21 shows a build output window 2010. The build output window 2010 is used to display path names of source, object, and component files as they relate to the build process. Step 530 occurs after the configuration file has been validated. For example, the build output window 2010 can occur after the dependencies have been adequately addressed in Step 540, and the config file has been generated in Step 530.

FIGS. 5-21 are offered to show an exemplary UI that can be used to enter data into the XML document in Step 510. A user can proceed to Step 520 by selecting a generate configuration item. For example, the user could press a button or make a selection from a pull-down menu.

In the embodiments described above, the system has been described as implemented with an XML document. Although this implementation is preferred, alternative arrangements are also possible. For example, the system could be implemented in another type of mark-up language, such as SGML, or HTML. Moreover, although mark-up languages are preferred, the system could be implemented in a non mark-up language. For example, the system could be implemented, in part or entirely, in a programming language such as C, C++, JAVA, Fortran, PASCAL, ADA, etc. However, preferably, the system is implemented in a language or specification that is interpreted, such as, SGML, Tcl, or Python.

In the preceding specification, the invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for creating a config file comprising the steps of:
entering a plurality of selections into a document, each selection corresponding to one or more components, the document comprising a set of rules for entering the selections and for identifying one or more dependencies of the components;
identifying the dependencies based on the set of rules;
if an unresolved dependency is found repeating the step of entering; and
if no unresolved dependency is found, building a configuration file based on the document.

2. A method for creating makefiles comprising the steps of:
entering a plurality of selections into a document, each selection corresponding to one or more components, the document comprising a set of rules for entering the selections and for identifying one or more dependencies of the components;
identifying the dependencies based on the set of rules;
if an unresolved dependency is found repeating the step of entering; and
if no unresolved dependency is found, building one or more makefiles based on the document.

3. A method for creating configuration data comprising the steps of:
entering a plurality of selections into a document, each selection corresponding to one or more components, the document comprising a set of rules for entering the selections and for identifying one or more dependencies of the components;
identifying the dependencies based on the set of rules;
if an unresolved dependency is found repeating the step of entering;
if no unresolved dependency is found, building one or more makefiles based on the document; and
if no unresolved dependency is found, building a configuration file based on the document.

4. A method for creating a configuration file comprising the steps of:
entering a plurality of selections into a user interface, each selection corresponding to one or more components,
providing a set of rules for entering the selections and for identifying one or more dependencies of the components;
identifying the dependencies based on the set of rules;
if an unresolved dependency is found repeating the step of entering; and
if no unresolved dependency is found, building a configuration file based on the user interface.

5. A method for creating a configuration data comprising the steps of:
entering a plurality of selections into a user interface, each selection corresponding to one or more components,
providing a set of rules for entering the selections and for identifying one or more dependencies of the components;
identifying the dependencies based on the set of rules;
if an unresolved dependency is found repeating the step of entering;
if no unresolved dependency is found, building a configuration file based on the user interface; and
if no unresolved dependency is found, building a makefile based on the user interface.

6. A method for creating a makefile comprising the steps of:
entering a plurality of selections into a user interface, each selection corresponding to one or more components,
providing a set of rules for entering the selections and for identifying one or more dependencies of the components;
identifying the dependencies based on the set of rules;
if an unresolved dependency is found repeating the step of entering; and
if no unresolved dependency is found, building a makefile based on the user interface.

7. The method as recited in claim 4 wherein the file is resident in a volatile memory.

8. The method as recited in claim 1 wherein the document further comprises a second set of rules; and further comprising the step of generating an interface for entering the selections based on the second set of rules.

9. The method as recited in claim 1 wherein the dependency is based on one or more components.

10. The method as recited in claim 1 further comprising generating one or more makefiles based on the configuration file.

11. The method as recited in claim 1 further comprising generating one or more makefiles based on the document.

12. The method as recited in claim 1 wherein one or more of the selections is a component that is not specific to a particular hardware device.

13. The method as recited in claim 1 wherein one or more of the selections is a component for interacting with a hardware device.

14. The method as recited in claim 1 wherein one or more of the selections is a component for specifying a particular configuration.

15. The method as recited in claim 1 wherein one or more of the selections is a component for specifying a particular file.

16. The method as recited in claim 1 wherein one or more of the selections is a component that is seen by an application as a device, but is not a device.

17. The method as recited in claim 3 wherein the third set of rules defines a User Interface.

18. The method as recited in claim 1 wherein the configuration file is for a BSD/OS kernel.

19. The method as recited in claim 1 wherein the configuration file is for a UNIX kernel.

20. A method for configuring an OS kernel comprising the steps of:
accessing a description for a plurality of components, the components used to build a kernel;
interpreting the description, with a software tool;
based on the interpretation, entering, by a user, a first data;
resolving any dependencies present in the first data; and
based on the resolved dependencies and the first data, producing an output file.

21. The method as recited in claim 20 wherein the description is an XML file.

22. The method as recited in claim 20 wherein the output file is a kernel configuration file.

23. The method as recited in claim 20 further comprising reading the description from an existing file.

24. A software tool for configuring a kernel comprising:
a XML document, the XML document comprising a first data for configuring a kernel, and a set of rules for arranging the first data based on an input from a user;
a software tool for accessing the XML document and a database, the software tool implementing the set of rules and the first data based on a second data obtained from the database, to form a configuration data for building a kernel; and
a database comprising the second data, the second data for implementing the set of rules and the first data.
